(19) United States
(12) Patent Application Publication
(10) Pub. No.: US 2013/0239362 A1
(43) Pub. Date: Sep. 19, 2013

(54) Eraser Bracelet

(71) Applicant: Bryan Ricci, Portland, TN (US)

(72) Inventor: Bryan Ricci, Portland, TN (US)

(73) Assignee: Bryan Ricci, Portland, TN (US)

(21) Appl. No.: 13/613,227

(22) Filed: Sep. 13, 2012

Related U.S. Application Data
(66) Substitute for application No. 12/756,356, filed on Apr. 8, 2010, now abandoned.

(51) Int. Cl. B43L 19/00

(52) U.S. Cl. CPC B43L 19/0025
USPC 15/425

(57) ABSTRACT

A flexible eraser bracelet fabricated from an elastomeric compound, capable of erasing marks, such as pencil markings, ink markings, the like, or indicia from a surface.

This application has a priority based on non-provisional patent application No. 12/756,356, which was filed on Apr. 8, 2010 and titled Eraselet—Bracelet Eraser

### BACKGROUND OF THE INVENTION

1. Field of the Invention

This invention relates generally to erasers and more specifically to erasers in the form of bracelets and wristbands.

2. Description of the Prior Art

Erasers and the like have been known. Erasers are typically constructed of rubber or synthetic material that allow a user to erase markings, such as pencil markings, ink markings, the like, or indicia from a surface. Erasers typically have a rubbery consistency, come in a variety of colors, and are comprised of a single layer of material, such as synthetic rubber, plastic or gum-like materials, synthetic soy-based gum, and may also contain vinyl and pulverized pumice.

Edward Naime, an English engineer, is credited with creating the first rubber eraser, using natural rubber, in 1770. However, such natural rubber erasers were not durable, were perishable, and would go had over time. Erasers came into common use after Charles Goodyear discovered the process of vulcanization in 1839, a method that cured rubber and made it durable. Hymen Lipman received the first patent on Mar. 30, 1958 (U.S. Pat. No. 19,783) for attaching an eraser to the end of a pencil; however, the patent was later invalidated.

Erasers come in several shapes and sizes; the more common erasers come attached to pencils, conical cap erasers that may be slipped onto the ends of pencils, block and wedge erasers that may be rectangular or block shaped, and barrel erasers contained in a barrel of a retractable cylinder. Novelty erasers are also available that have a variety of colors, shapes, and designs that are primarily intended for their decorative nature more than practical use.

Erasers that may be used for instructional purposes and/or entertainment and that may be used practically for the function of erasing are necessary. Such erasers should have the added convenience and capability of being worn, as jewelry, on or close to the hand of a wearer and therefore close to the writing utensil providing marks that may need erasing.

The solution for this lack of convenience and practicality is the invention of an eraser in the form of a bracelet and wristband.

There are many erasers available on the open market. U.S. Pat. No. 6,547,465 (Rago, et al.) discloses a pencil that has a fixed non-replaceable eraser and a moveable sleeve.

U.S. Pat. No. 5,709,491 (Yeh) discloses a tubular eraser for erasing pencil marks comprising an elongated body of a rubber material.

U.S. Pat. No. 4,899,419 (Saleen) discloses a pencil eraser assembly having elongated hollow eraser sleeve formed to align in an elemental parallel spaced relationship with both a frustum shaped segment and a portion of a cylindrical barrel segment of a pencil.

None of the previous inventions have the added convenience that bracelet erasers offer for consumers. For the foregoing reasons, there is a need for erasers with the added convenience and capability of being worn, as jewelry, on or close to the hand of a wearer and therefore close to the writing utensil providing marks that may need erasing.

### SUMMARY OF THE INVENTION

All portions of an eraser bracelet have elasticity to assist in pulling it over the hand to the wrist for placement and to assist in removing it in the opposite way. Its elasticity also plays a pivotal role in its function as an eraser. It operates by the individual stretching it from their wrist to the tip of their index finger or thumb. The tension from the elasticity secures it in place. The portion of the bracelet covering the tip of their index finger or thumb provides a surface, that when coupled with kinetic movement, creates the necessary friction to erase pencil or pen markings, the like, or indicia from surfaces.

Every part of the eraser bracelet can be used to erase markings, such as pencil markings, ink markings, the like, or indicia from a surface. Minimal amounts of dust amass from its use, making it more environmentally efficient, as well as more durable than traditional erasers. Furthermore, no PVC plastics are used as materials in the manufacturing of this product, also making it more environmentally efficient than some traditional erasers currently in production. Eraser bracelets are not consistent in design and can be made in various colors and sizes, and may contain artwork or text printed on the outside of them, whereas the ink printed on them, being a separate entity than the eraser bracelet itself, will not erase markings such as pencil markings, ink markings, the like, or indicia from a surface. For a particular commercial embodiment being produced and marked by Eraselet, LLC, the outside portion of the bracelets are printed with various artwork and text while the inside portion, the part of the bracelet that touches the wearer's wrist, remain unprinted leaving the total inside portion to be used as an eraser.

Eraser bracelets are manufactured by vulcanizing natural and/or synthetic rubber, extruding the vulcanized rubber into a long tubular cylinder that is then cooled with or without the use of water, and then cut proportionately, resulting in mass production.

### BRIEF DESCRIPTION OF DRAWINGS

FIG. 1 is an isometric view of a first embodiment eraser bracelet, which is a single-function, reversible device;

FIG. 2 is a perspective view of the first embodiment eraser bracelet of FIG. 1, as installed on the right wrist of a wearer;

FIG. 3 is a perspective view of the first embodiment eraser bracelet of FIGS. and 2, shown in the process of being reversed by a wearer;

FIG. 4 is a perspective view of the first embodiment eraser bracelet of FIGS. 1, 2, and 3, shown is the process of erasing pencil markings.

### DETAILED DESCRIPTION OF THE INVENTION

The invention will now be described in detail with reference to the attached drawing figures.

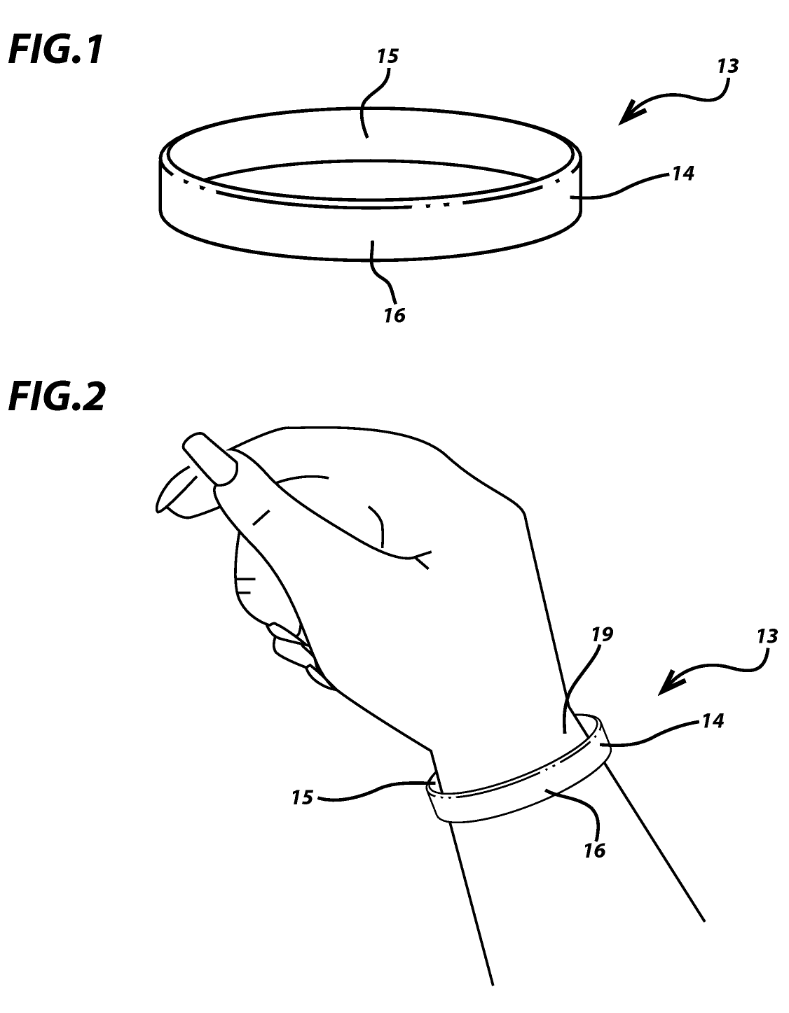

Referring now to FIG. 1, a first embodiment eraser bracelet 13 is a single-function, reversible device, which includes an annular band 14 having an inner major surface 15, that touches a wearer's wrist, and an outer major surface 16, that does not touch a wearer's wrist. In one embodiment, the annular band 14 is fabricated from an elastomeric compound, such as silicone rubber, styrene-butadiene rubber (produced from butadiene and styrene monomers), polybutadiene, polychloroprene butyl rubber (produced from isobutylene and isoprene), natural rubber, synthetic rubber, vulcanized natural rubber, vulcanized synthetic rubber, partially vulcanized natural rubber, and partially vulcanized synthetic rubber. The elastomer compound may incorporate fluorescent, glow-in-the-dark material. The major surfaces 15 and 16 of the annular band 14 must he capable of being reversed by rolling the hand 14 so that the inner major surface 15 becomes the outer major surface 16, and visa versa.

Referring now to FIG. 2, the first embodiment eraser bracelet 13 of FIG. 1 is shown installed on the right wrist of a wearer 19, with the outer major surface 16 being the exposed surface of the annular band 14, and the inner major surface 15 being the surface of the annular band 14 that is in contact with the right wrist of a wearer 19.

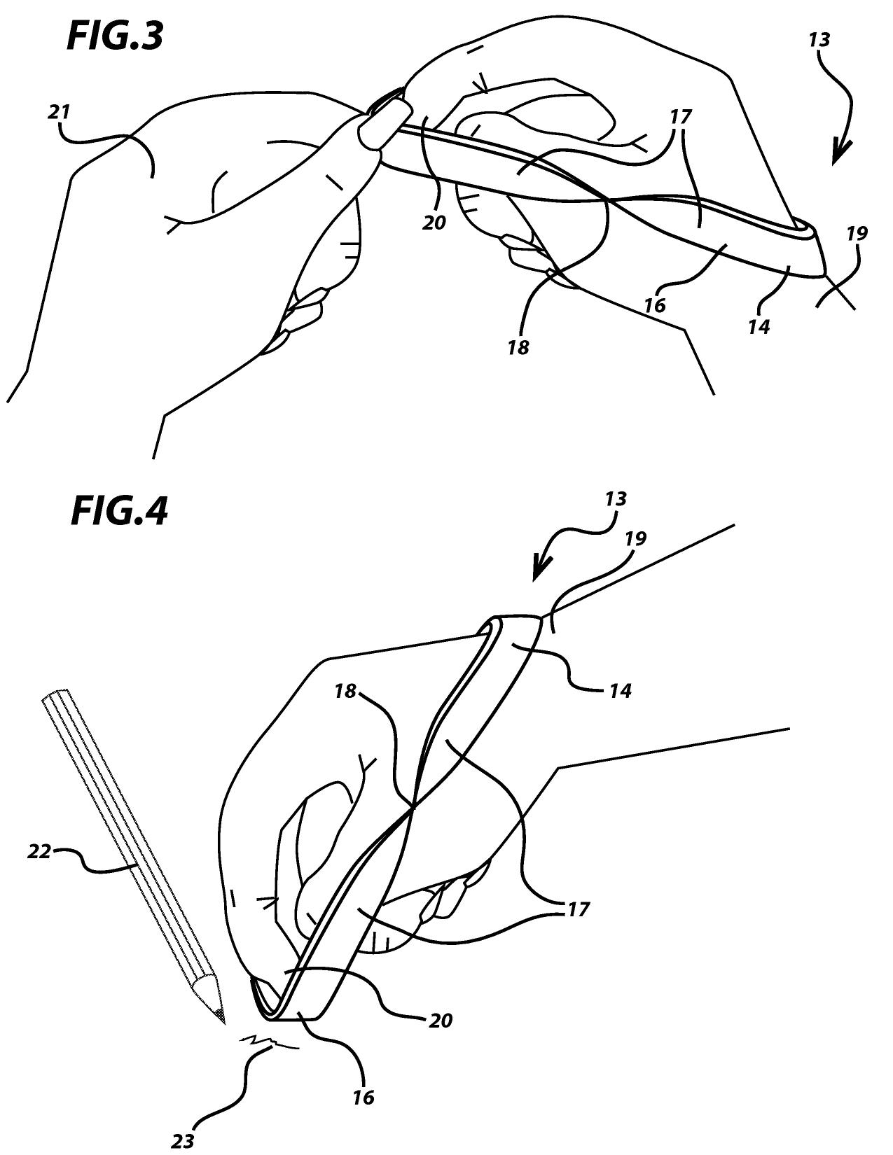

Referring now to FIG. 3, the first embodiment eraser bracelet 13 is shown in the process of being stretched 17, reversed 18, and placed over the right index finger of a wearer 20 by a wearer's left hand 21 in preparation of use. The elasticity of the annular band 14 secures the annular band 14 snugly between the right index finger of a wearer 20 and the right wrist of a wearer 19. This enables the wearer to use the outer major surface 16 for its functioning purpose with the precision offered by the right index finger of the wearer 20, without the annular hand 14 being displaced from friction that occurs during use of the first embodiment eraser bracelet 13 of FIG. 1.

Referring now to FIG. 4, the first embodiment eraser bracelet 13 is shown erasing markings 23, made from a pencil 22, using the outer major surface 16 of the annular band 14. A wearer vigorously shakes their right wrist 19, while applying pressure with their right index finger 20 causing a portion of the outer major surface 16 of the annular band 14 to erase markings 23 made by a pencil 22. The first embodiment eraser bracelet 13 uses friction created by the kinetic movement of a wearer, coupled with a portion of the outer major surface 16 of the annular band 14 coming in contact with the markings 23 of such a device as a pencil 22. The tension created when the annular band 14 is stretched 17 between the right wrist of a wearer 19 and the right index finger of a wearer 20, secures the first embodiment eraser bracelet 13 to a wearer in proper positioning for use. The tension also ensures that the first embodiment eraser bracelet 13 remains in proper positioning for use during the act of using such a device for its intended purposes.

What is claimed:

1. A bracelet comprising: an eraser, made of vulcanized natural and/or synthetic rubber, capable of erasing markings, such as pencil markings, pen markings, the like, or indicia by rubbing out such markings from a surface.

2. A bracelet according to claim 1, wherein: the bracelet has elasticity that affixes it to the hand of a wearer using the tension created when the bracelet is stretched between the wrist of a wearer and the right index finger of a wearer.
